(19) United States
(12) Patent Application Publication
(10) Pub. No.: US 2026/0280924 A1
(43) Pub. Date: Sep. 17, 2026

(54) SYSTEM AND METHOD FOR DATA COLLECTION FOR A PERSONAL AI ASSISTANT

(71) Applicant: Kete LLC, Kansas City, MO (US)

(72) Inventors: Daniel Cross, Kansas City, MO (US); James Londal, London (GB)

(73) Assignee: Kete LLC, Kansas City, MO (US)

(21) Appl. No.: 19/536,166

(22) Filed: Feb. 10, 2026

Related U.S. Application Data
(60) Provisional application No. 63/756,355, filed on Feb. 10, 2025.

(51) Int. Cl. H04L 12/28

(52) U.S. Cl. CPC H04L 12/2807; H04L 12/2823

(57) ABSTRACT

A computer-implemented method for managing household information comprises receiving documents and data from multiple sources including user uploads, API connections, and advisor pre-population, then processing documents through a knowledge processing pipeline comprising classification, extraction, refinement, and synthesis stages executed by specialized LLM-based agents. The method populates domain-specific analytics tables organized by household identifier using a three-phase process: direct field mapping, retrieval-augmented generation enrichment, and cross-document synthesis, wherein each phase executes as separate database transaction providing failure isolation and progressive enrichment. The method supports flexible deployment configurations including business-to-consumer wherein consumers directly populate household data, business-to-business-to-consumer wherein advisors pre-populate client household data before client access, and hybrid configurations enabling transitions between deployment models. The method enables conversational querying via retrieval-augmented generation combining document embeddings and structured analytics, generates comprehensive holistic planning reports with LLM-generated observations and provenance tracking, and supports management of multiple distinct households with independent encryption keys.

### CROSS-REFERENCE TO RELATED APPLICATIONS

This U.S. Patent Application claims the benefit of the filing date of U.S. Provisional Patent Application No. 63/756,355, filed Feb. 10, 2025, the entire teachings of which are incorporated herein by reference

### BACKGROUND

Data has been referred to as the new oil, a critical enabler and driver for modern business and life. In the US alone, organizations have spent billions of dollars in recent decades transforming their capabilities and offerings to make better use of this resource. This has enabled businesses to pursue new and more profitable operating models, increased efficiency, greater agility and improved customer experience.

With the rise of Large Language Models (LLMs), along with refinements to other areas of Artificial Intelligence (AI), there will continue to be an ongoing investment into data management to unlock these technologies for organizations. One example of this is the development of AI agents and assistants, autonomous or semi-autonomous AI programs that can interact with each other to automate regular tasks in a flexible manner. Such programs have the potential to augment or replace repetitive tasks, allowing organizations to repurpose capital and pursue new opportunities. They are also entirely dependent on the quality of data available for their training, decisioning and actions creating a divide between firms that have made the required data investment, and those that have not.

These ongoing investments by businesses create an efficiency asymmetry between organizations and the households and consumers they serve. While firms underpin customer (B2C) and business (B2B) interactions with data lakes, analytics and automation, households are required to manually maintain information and interact with upwards of 100 different entities. This challenge is made more difficult as most of the critical information households require is locked inside transactional documents such as contracts, statements and notifications. Without an equivalent transformation to that undertaken by organizations, households will be less able to benefit from future enhancements in AI, resulting in higher levels of manual work, inefficiencies, and cost.

This household data management challenge is experienced at significant scale by professionals who advise and support multiple households. Financial advisors, for example, are increasingly being asked by clients to help navigate life's complexity through a financial lens by providing “holistic advice”. This includes advice on managing risk with insurance, legacy with estate planning, tax efficiency, and saving for major life events. However, the broader scope of holistic advice requires access to a wide range of information, information that is typically held by client households in the form of documents distributed across upwards of 300 different document types. Research suggests that preparing for a semi-annual planning meeting takes advisors over 3 hours of document review, a figure that does not include the client's time to locate, assemble and share the documents required. This creates significant headwinds for advisory firms seeking to scale their holistic offerings, with individual advisors typically managing relationships with high tens, if not hundreds of client households.

A related trend further complicating households seeking to manage their information and documents is that a growing number of adults find themselves as part of multiple households. This is driven by factors including the need to support aging parents, the formation of blended households, and supporting adult children. It is estimated that currently 23% of US adults are “sandwiched” and supporting both adult children and parents over the age of 65. Currently 68% of retirees rely on their families for some form of support, and 40% of US households are “blended”, combining children from past relationships. These trends increase the administrative workload for impacted adults, adding to the work of maintaining their own households and increasing the complexity of sharing information, completing actions and maintaining transparency.

One solution to the above challenges is the use of knowledge management systems, or storage capabilities focused on maintaining, organizing, and sharing household information. These systems have the ability to support personal AI assistants, capable of leveraging the stored knowledge to advise on key tasks and activities. Such systems may be deployed directly to consumers managing their own household(s), or may be deployed through trusted professionals such as financial advisors who support multiple client households at scale and materially benefit from well-organized client data.

### SUMMARY

The inventors of the present disclosure have recognized a need to address one or more of the above-mentioned problems. It has been surprisingly recognized by the inventors of the present disclosure that major barriers to individuals and professionals adopting, and persisting with, personal data stores are found in the effort required to add, maintain and organize data in the platform. These barriers exist whether data collection is initiated by the consumer themselves or by a professional acting on behalf, or enabling, client households. Addressing these barriers across multiple deployment models is one non-limiting, possible objective of the outlined system and methods for data collection of the present disclosure.

Some aspects of the present disclosure relate to systems and methods for collecting household information through flexible deployment models to empower a personal AI assistant which aids consumers and professionals to better manage the household(s) that they are members of or advise. The system supports both consumer-initiated data collection, wherein individuals directly populate their household knowledge base, and advisor-initiated data collection, wherein financial advisors or other professionals pre-populate client household data at scale. Some non-limiting embodiments of the present disclosure enable users to leverage their data and interactions with other individuals, companies, organizations, and government bodies, whether accessed directly by consumers or through professional intermediaries.

### BRIEF DESCRIPTION OF THE DRAWINGS

In the drawings, closely related figures have the same number but different alphabetical suffixes.

FIG. 1 is a diagram of an AI Assistant Platform in accordance with some embodiments of the present disclosure and illustrates architectural components of the platform and relationships between components.

FIG. 2 is a flow diagram of user navigation of the Business-to-Consumer (B2C) Platform of FIG. 1 via a User GUI for a mobile application.

FIG. 3 is a flow diagram of the B2C data collection process and technical elements incorporated by the Platform of FIG. 1.

FIG. 4A(1)-4A(6) are a series of representations of exemplary graphical user interface (GUI) screens according to some implementations of the present disclosure as experienced by a user, and represent, in succession, a New User Welcome to 1^{st} Discovery Questionnaire, highlight the completion of the domain specific discovery questionnaire, and the development of action items for later completion.

FIG. 4B(1)-4B(4) are a series of representations of exemplary GUI screens according to some implementations of the present disclosure as experienced by a user, and represent, in succession, an Action adding knowledge from a photo, illustrate the user flow associated with capturing information from a photograph of a document (e.g., a passport) and the behavioral re-enforcement for doing so.

FIG. 4C(1)-4C(4) is a series of representations of exemplary GUI screens according to some implementations of the present disclosure as experienced by a user, and represent modes for querying information within the platform. In succession, the Kete Home Page, the Your Accounts Page, the Ask Kete page, and presentation of results based on the AI augmented search.

FIG. 5 is a flow diagram of the B2B2C document pre-population process and technical elements incorporated by the Platform of FIG. 1.

FIG. 6 is a flow diagram of the Knowledge Processing Pipeline process and technical elements incorporated by the Platform of FIG. 1.

FIG. 7 is a flow diagram of the Report Generation process and technical elements incorporated by the Platform of FIG. 1.

FIG. 8 is a flow diagram of user navigation of the B2B2C Advisor Platform of FIG. 1 via a User GUI for a web application.

FIGS. 9A-9F are representations of the Holistic Reports generated from the process outlined in FIG. 7.

### DETAILED DESCRIPTION

Some aspects of the present disclosure are directed to computer-implemented systems and methods that help users collect, manage, share and act on knowledge related to the household(s) that they are members of or advise. In some non-limiting examples, features of the present disclosure can be provided by one or more software applications operating on computing devices (e.g., smart phones, tablets, laptop computers, desktop computers) that can be referred to as a “Kete Personal AI Assistant” or “Kete Platform” or simply “the platform.” The platforms of the present disclosure can operate to group users into one or more households; as used throughout the present disclosure, the term “household” is defined as a logical grouping of one or more individuals who pool income and consumption for day-to-day life. This definition is intended to encompass traditional nuclear families, bended households, multi-generational households, and un-related adults living together (e.g., renting together).

The incorporation of the outlined systems and methods for collecting and processing household information allows the platform to adapt the user's experience based on flexible deployment models. These deployment models include consumer-initiated data collection (B2C), wherein individuals directly populate their household knowledge base, and business-initiated data collection (B2B2C), wherein professionals associated with the household, for example financial advisors, pre-populate client household data at scale before clients access the system. Some embodiments support hybrid configurations wherein deployment models transition during the household lifecycle. Challenges to collecting and processing household data are addressed through a range of behavioral and technical innovations within the data collection and processing workflows.

### System Architecture Overview

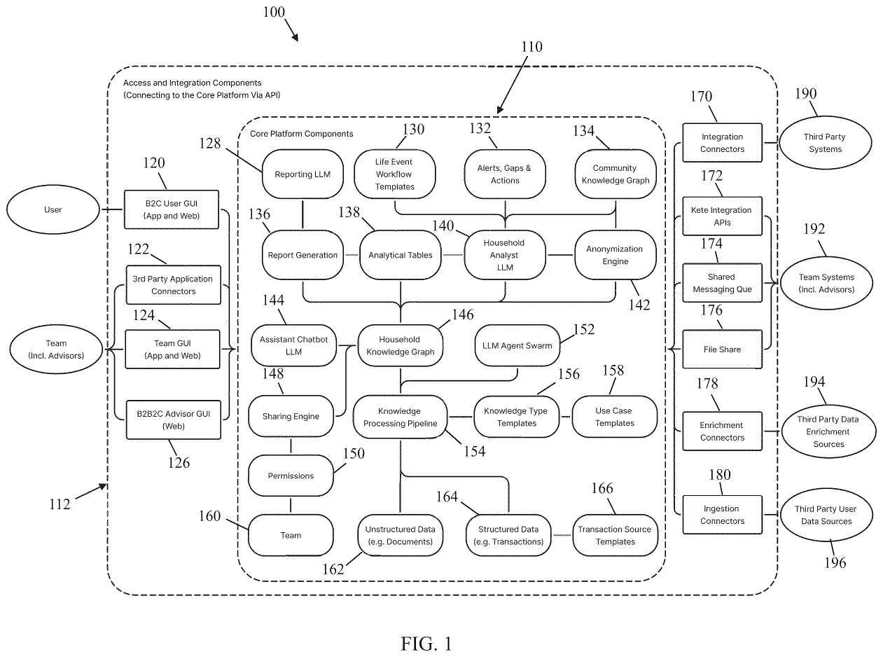

One non-limiting example of a platform architecture 100 of the present disclosure is outlined in FIG. 1. The platform architecture 100 comprises both Core Platform Components 110 and Integration Components 112 that enable flexible deployment across business-to-consumer (B2C), business-to-business-to-consumer (B2B2C), and hybrid configurations as described below. Components of the present disclosure are in reference to software code. In some examples, logical units of software code connect to each other through various pathways, including, but not limited to, APIs, procedure calls, and messaging ques. Parties and systems interacting with the platform 100 can include: the platform User, an individual who is a member of the household; members of the User's Team, private individuals and professionals who support the household (e.g., financial advisors or extended family members); Third Party User Data Sources are technology platforms that generate and share data for the user, allowing automated load to the platform (e.g. a credit card provider publishing statements and transactions); Team Systems are technology platforms that are used by Team members in their support of the household (e.g. a financial advisor's CRM), Third Party Data Enrichment Sources are used by the platform to enhance data added to the platform (e.g., appending house prices to a property record); Third Party Systems are platforms used by organizations engaged by the household and which the platform can interact with on the user's behalf (e.g., requesting a quote for an insurance policy).

### Core Platform Components 110

In some embodiments, the Core Platform Components 110 can include one or more or all of the following.

B2C User GUI (App and Web) 120, configured or programmed to provide graphical user interfaces through mobile applications and web browsers for household members to interact with their household knowledge, add information, query the system, share information, and complete actions.

3rd Party Application Connector(s) 122 configured or programmed to enable integration with external applications and services.

Team GUI (App and Web) 124 configured or programmed to provide interface for members of the household's team, for example extended family and professional advisors, to access household information according to granted permissions.

B2B2C Advisor GUI (Web) 126 configured or programmed to provide web-based interface specifically designed for financial advisors to manage multiple client households and documents, and generate reports.

Reporting LLM 128 configured or programmed for generating holistic planning reports and synthesizing insights across multiple knowledge domains. For example, the Reporting LLM 128 can be configured or programmed to generate financial planning reports by first populating verified data points from analytics tables into a plurality of report section templates, with each section template corresponding to a holistic planning domain. Observations for each of the plurality of sections are generated by: providing one or more LLM-based agents access to both the analytics tables and the vector database containing embedded document content, and prompting the one or more LLM-based agents to analyze the data and generate contextual observations relevant to the holistic planning domain of each section. An executive summary can be generated by: providing an LLM-based agent access to key dates and observations from across the plurality of sections, and prompting the LLM-based agent to synthesize cross-domain insights, receiving user selection of one or more sections to include in a finalized report. User modifications to the observations and executive summary are received prior to finalizing the report. User modifications can include at least one of: editing existing observations, adding new observations, or deleting observations. The finalized report can then be rendered and can include only the selected sections in an immutable PDF for download in some examples. Provenance metadata for each data point in the report can be maintained. In this regard, the provenance metadata can include source document identifier, location in the source document, extraction timestamp, and extraction confidence. All user modifications to the report can be tracked such as by noting original LLM-generated content, generating agent, modified content, user identifier, modification timestamp. Finally, the provenance metadata and modification tracking can be stored or saved in a memory for audit purposes.

Life Event Workflow Templates 130 configured or programmed to structure data collection and action sequences around major household transitions such as marriage, home purchase, retirement, etc.

Alerts, Gaps & Actions 132 configured or programmed to store key dates(e.g., dates that are linked to events requiring decisions), identified information gaps, and recommended actions derived from analysis of household data.

Community Knowledge Graph 134 configured or programmed to store aggregated, anonymized insights derived from multiple household knowledge graphs to enable comparative analytics and benchmarking features.

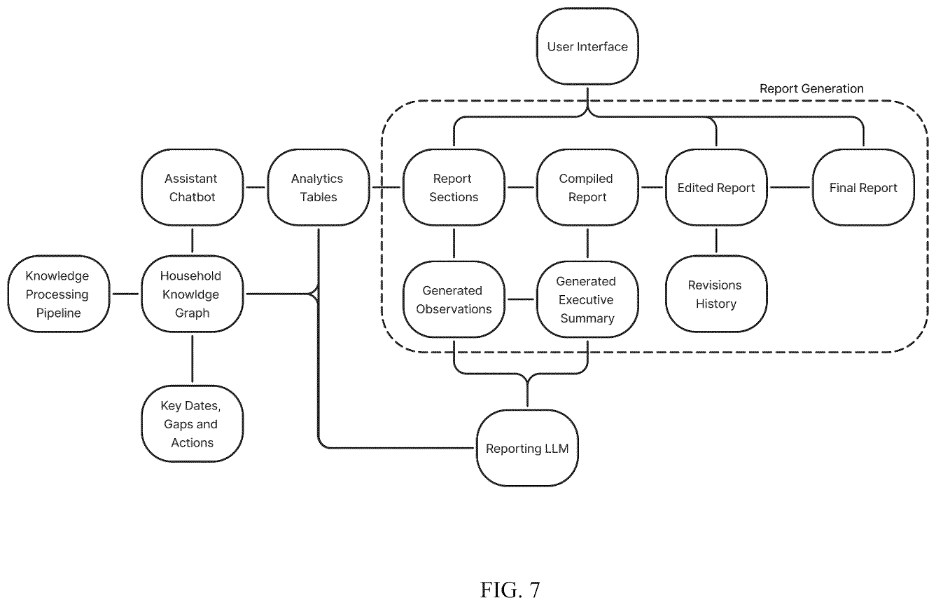

Report Generation 136 configured or programmed to manage the creation of comprehensive holistic planning reports as described in greater detail below with respect to FIG. 7.

Analytical Tables 138 configured or programmed to store structured household data in domain-specific relational tables. Some non-limiting examples of domain-specific relational tables of the present disclosure include: the households table storing household-level information, household members table storing individual member information, tax returns table storing annual tax data, accounts table storing financial account information, account owners table linking individuals to accounts, positions table storing investment holdings, transactions table storing financial transactions, properties table storing real estate information, insurance policies table storing insurance coverage information, income sources table storing employment and income data, liabilities table storing debt and loan information, documents table storing document metadata, document embeddings table storing vector embeddings, etc. In some embodiments, each analytics table comprises a household id foreign key enabling household-specific queries. As will be understood by those of ordinary skill, a foreign key is a term of art in database design and relates to a process for linking two records across two tables where one table is stored as a primary key and the second table as a foreign key.

Household Analyst LLM 140 configured or programmed to analyze household knowledge graphs (described in greater detail below), identify gaps in information, detect contradictions across documents, generate alerts and recommended actions, and create other household insights.

Anonymization Engine 142 configured or programmed to support aggregation and anonymization of data across multiple household knowledge graphs for benchmarking and research purposes while preserving individual privacy.

Assistant Chatbot LLM 144 configured or programmed for conversational querying of household knowledge through natural language interfaces, implementing retrieval-augmented generation (RAG), examples of which are provided below.

Household Knowledge Graph 146 configured or programmed to store relationships between household members, documents, knowledge units, and analytics data organized by household identifier, enabling household-centric queries and analysis. A “house identifier” is the primary key for the household, and can be a computer generated, non-sequential unique string that identifies a household across database tables and functions.

Sharing Engine 148 configured or programmed to manage secure distribution of information and documents to third parties via API integrations, file sharing protocols, or messaging queues.

Permissions 150 configured or programmed to store user-granted permissions that control access to documents and knowledge units by team members and external parties such as financial advisors.

Agent Swarm 152 comprising multiple specialized AI agents (LLM's, Reinforced Learning, Machine Learning) that process documents in parallel as described below. The LLM agent swarm 152 can include: (i) extraction agents that apply knowledge type templates in parallel, (ii) a message queue for event coordination, (iii) QA validation agents that verify extracted data, and/or (iv) an orchestration layer that manages agent invocation and result aggregation, etc.

Knowledge Processing Pipeline 154 configured or programmed to process all incoming household data through sequential stages of Ingest, Classify, Extract, Refine, and Process as described in greater detail below.

Knowledge Type Templates 156 configured or programmed to define structured schemas for different household information types, specifying expected data points and validation rules for extraction.

Use Case Templates 158 configured or programmed to group knowledge types into pre-defined sets to facilitate efficient data collection for specific planning purposes.

Team 160 configured or programmed to store information about individuals granted access to a household's data, including household members, trusted advisors, and other authorized parties, with access governed by the Permissions system or component 150.

Unstructured Data (e.g., Documents) 162 configured or programmed to store uploaded documents with associated metadata including document type classification, upload timestamp, source, and encryption status.

Structured Data (e.g., Transactions) 164 configured or programmed to store structured transaction data extracted from documents or ingested via API connections.

Transaction Source Templates 166 configured or programmed to define schemas for ingesting transaction data from various sources.

### Integration Components 112

In some embodiments, the Integration Components 112 can include one or more or all of the following.

Integration Connectors 170 configured or programmed to provide application programming interface (API)-based connections to third-party systems for automated data ingestion.

Kete Integration APIs 172 configured or programmed to provide outbound API capabilities enabling the platform 100 to connect to external systems including, for example, advisor document vaults, customer relationship management (CRM) systems, and financial data aggregators, supporting automated polling and data synchronization, examples of which are provided below.

Shared Messaging Queue 174 configured or programmed to enable asynchronous communication between the platform 100 and external parties including, for example, financial advisors, allowing notification of changes to shared information, documents, alerts, and actions.

File Share 176 configured or programmed to enable secure file-based data exchange with external systems.

Enrichment Connectors 178 configured or programmed to connect to third-party data enrichment sources to augment household data with public information, market data, and other contextual information.

Ingestion Connectors 180 configured or programmed to enable automated ingestion of household data from external sources such as financial institutions, insurance providers, and government agencies, supporting the advisor-initiated pre-population workflow described below.

### Platform Architecture 100 Operations

The platform architecture 100 can be configured or programed to communicate or connected with one or more external sources, for examples Third Party Systems 190, Team Systems (Incl. Advisors) 192, 3rd Party Data Enrichment Sources 194, and 3rd Party User Data Sources 196. The platform architecture 100 supports multiple LLM components for specialized tasks, accessed via zero data retention APIs to ensure privacy and security. These LLM components include Reporting LLM 128, Household Analyst LLM 140, Assistant Chatbot LLM 144, and LLM Agent Swarm 152 as described above. Different LLM models, either hosted or connected via Application Programming Interfaces (APIs) or Model Control Protocol (MCPs), may be selected for different tasks based on complexity and performance requirements. Simple, fast models are used for extraction and comparison tasks, while larger models are used for complex analytical tasks such as identifying gaps across knowledge graphs or answering sophisticated queries.

The platform supports management of a plurality of distinct households as described in greater detail below, with each household having independent encryption keys, separate analytics data stored in domain-specific analytics tables, and configurable contributor permissions. A single user can manage multiple households simultaneously, for example managing their own household while also having access to a parent's household or a blended household comprising children from previous relationships.

### Initial Data Population—Deployment Models

The platform supports flexible deployment configurations, such as: (i) business-to-consumer configurations (B2C) wherein initial population utilizes consumer-initiated population and ongoing inputs comprise consumer application interface and optionally API connections and team member inputs; (ii) business-to-business-to-consumer configurations (B2B2C) wherein initial population utilizes advisor-initiated pre-population and ongoing inputs comprise any combination of API connections, consumer application interface, advisor portal interface, and team member inputs; and (iii) hybrid configurations wherein a consumer-initiated household subsequently grants advisor access or wherein an advisor-pre-populated household transitions to consumer management.

### Business-to-Consumer Initial Population

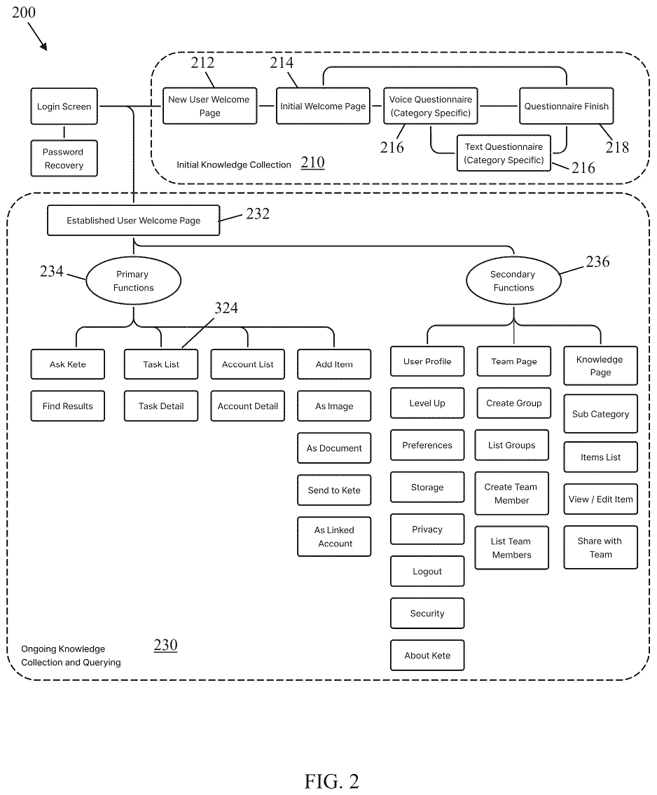

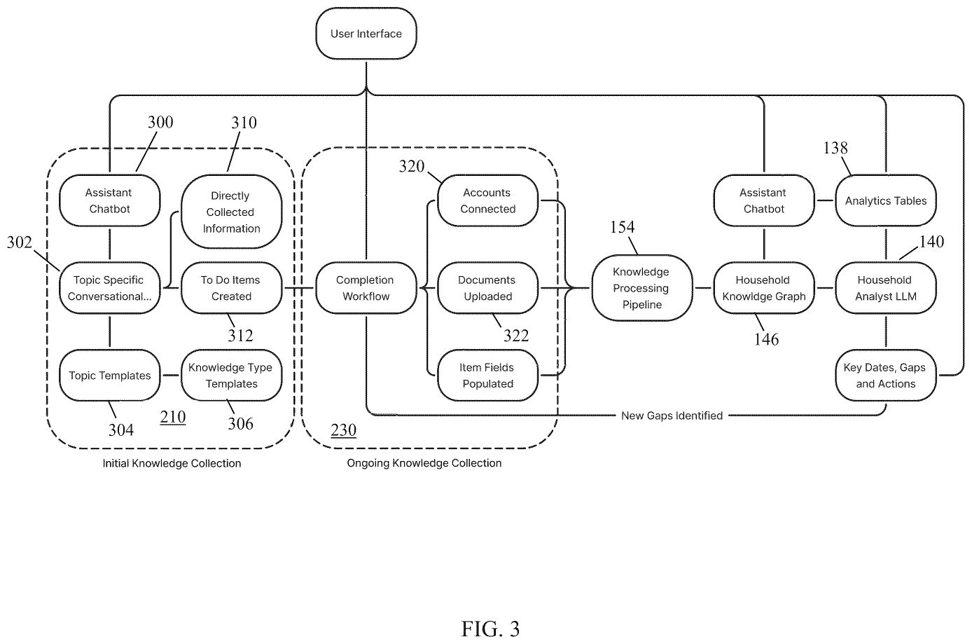

In business-to-consumer configurations, initial data population is consumer-initiated, in some non-limiting examples, as illustrated in FIGS. 2 and 3. As shown in FIG. 2, at 200 new users access the platform 100 (FIG. 1) through a login screen and are guided through an Initial Knowledge Collection phase 210 comprising a New User Welcome Page 212, Initial Welcome Page 214, and domain-specific discovery questionnaires 216 (e.g., with voice and text modalities) that guide users through collecting foundational household information. Upon completion of initial questionnaires at 218, users transition to Ongoing Knowledge Collection and Querying phase 230, for example accessing an Established User Welcome Page 232 that provides access to Primary Functions 234 and Secondary Functions 236 of the platform 100. Primary Functions 234 provide the user with access to the most common use of the platform (e.g., adding and querying information and completing tasks). Secondary Functions 236 provide access to more granular functions including manual navigation to knowledge items, managing the user's team and configuring the platform.

In some embodiments, the Primary Functions 234 accessible through the consumer interface can include: Ask Kete (e.g., conversational AI querying of knowledge items), Task List (e.g., tracking and completing actions and to-dos), Account List (e.g., viewing the balance of connected accounts) , and/or the ability to Add Items (e.g., capturing new knowledge items. In some embodiments, the Secondary Functions 236 can include: User Profile Pages (allowing the user to manage account preferences, view gamification progress to level up, track storage on the platform, and access security and privacy policies), Team Pages (supporting the management of the user's team, groups of team members and team member permissions), and Knowledge Pages (providing manual navigation and viewing and editing of knowledge items and their sharing with team members

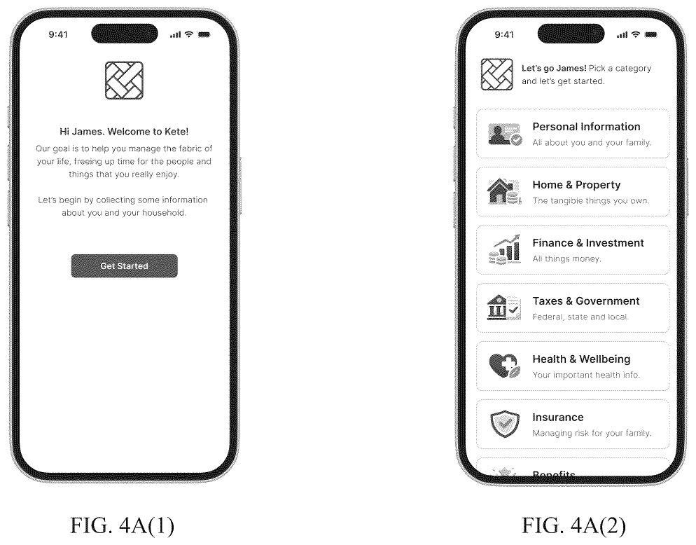

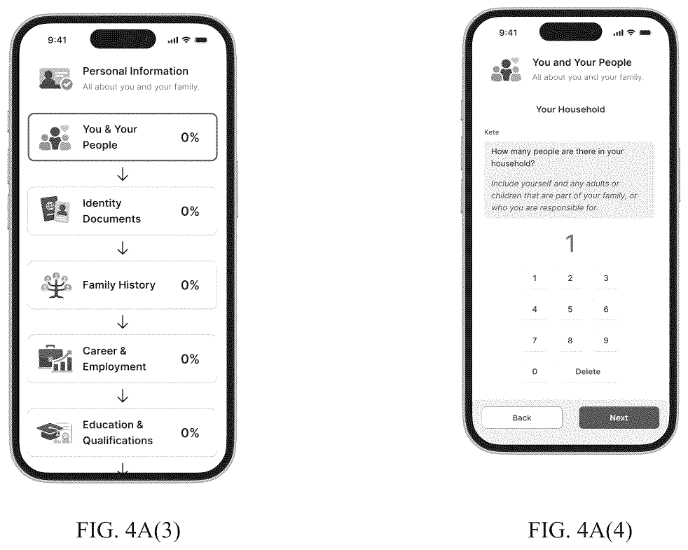

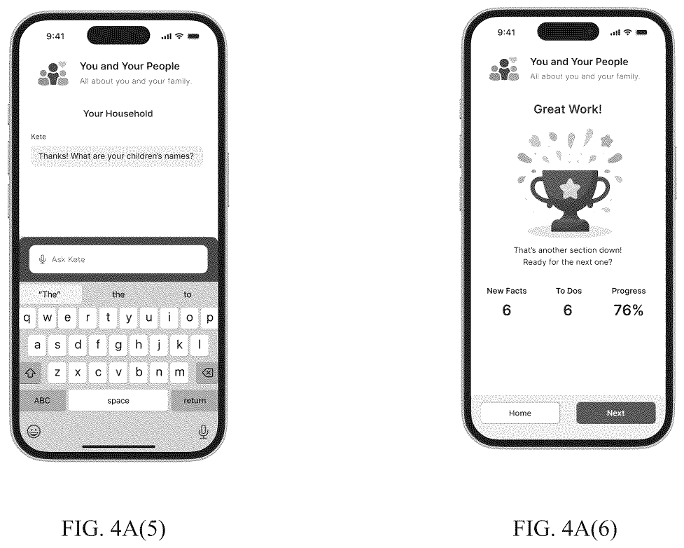

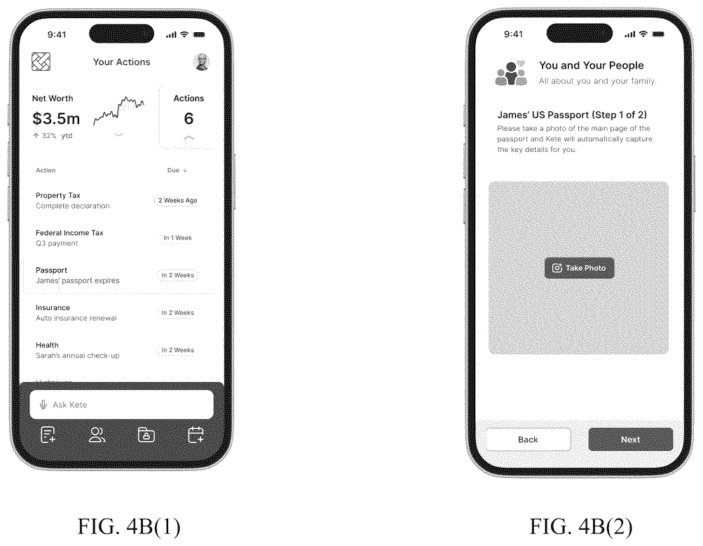

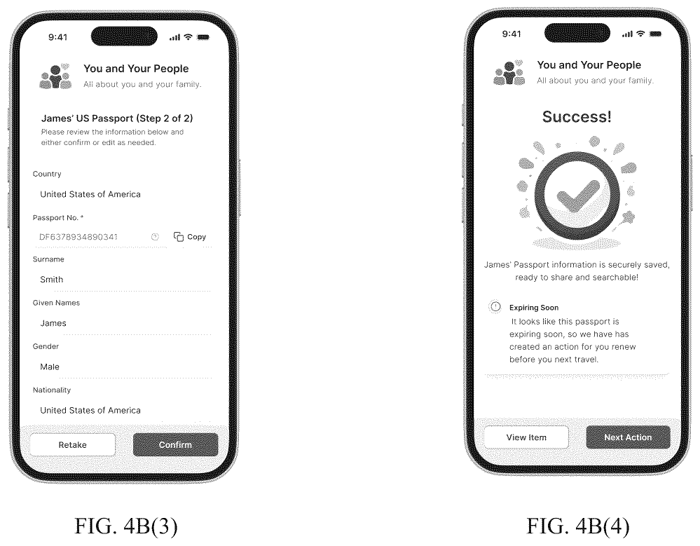

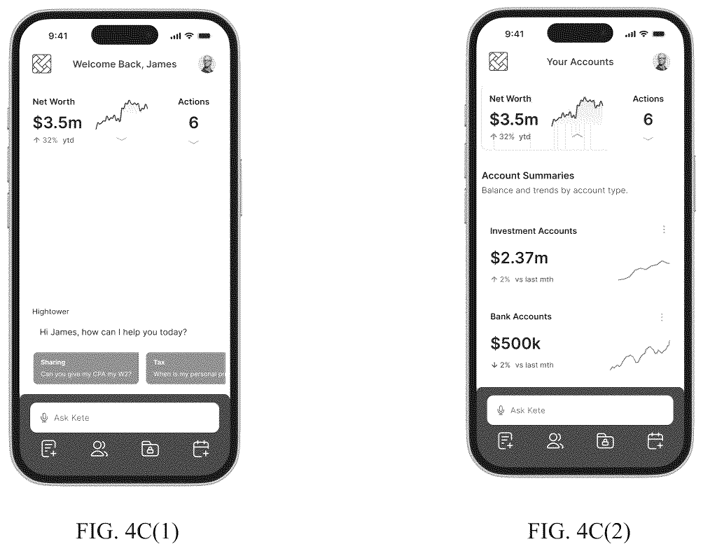

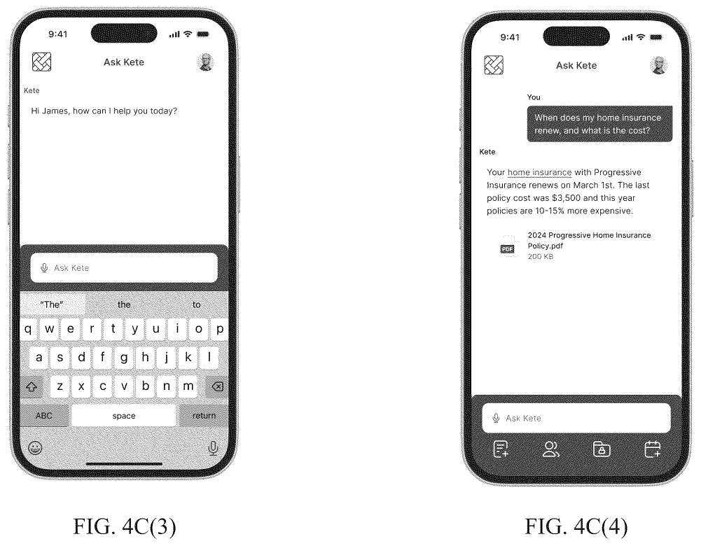

The behavioral approaches of the present disclosure for consumer-initiated data collection include, but are not limited to: The use of short guided discovery workflows (some non-limiting examples of which are illustrated in FIG. 4A(2)-4A(6)) to group together items based on specific knowledge domains (e.g., Finance & Investments, Home & Property, Tax, Estate Planning), which aids recall and allows personalization of future information requests to maximize relevancy to the user's situation. Careful management of the user's attention as users move through discovery workflows, collecting information within the flow when it is easily recallable (for example in FIG. 4A(4) and 4A(5)), and creating to-do actions (as illustrated, for example, in FIG. 4B(1)-4B(4)) for completion outside of the flow when additional documents or detailed information is required. Consistently reinforcing progress against the known body of work uncovered, enabled by domain-specific discovery workflows that show completion status for each knowledge domain. Optionally, gamification mechanics can be implemented that provide behavioral reinforcement as users add information (illustrated by the non-limiting examples of FIG. 4A(6) and 4B(4)), rewarding consistent engagement and completeness of household knowledge.

FIG. 3 illustrates the logical flow of the consumer-initiated data collection. The user interacts with the chatbot assistant 300 and is guided through a Topic Specific Conversational Flow 302 which is driven by Topic Templates 304 which in turn draw on Knowledge Type Templates 306 for consistency. In the example shown in FIG. 4A(1)-4A(6), a user populating the You and Your People sub-section of the Personal Information category is guided through a predefined flow collecting information on the composition of their household, the names and ages of household members, and their relationship to the user. The template specifies the order and form of questions, while the knowledge type template provides the format of information to be collected, which in turn drives the user interface elements presented for Directly Collected Information 310, for example numerical data (an example of which is shown in FIG. 4A(4)and/or free form text (an example of which is shown in FIG. 4A(5)). This process also enables Ongoing Collection of Knowledge as To Do Items 312. These tasks include the connection of an account 320, the upload of a document 322, or the latter completion of a structured question. These items are added to the user's task list 324 (FIG. 2; and an example of which is shown in FIG. 4B(1)) as they complete the Initial Knowledge Collection 210 process, and throughout their use of the platform. As documents are uploaded or accounts connected during the Ongoing Knowledge Collection phase 230, the system processes these inputs through the Knowledge Processing Pipeline 154 (described in detail below) to populate the Household Knowledge Graph 146. The populated knowledge graph then enables querying through the Assistant Chatbot, generation of Analytics Tables for structured analysis, identification of Key Dates, Gaps and Actions requiring attention, and utilization by the Household Analyst LLM 140 for deeper analysis and insight generation.

### Business-to-Business-to-Consumer Initial Population

In business-to-business-to-consumer (B2B2C) configurations implementing advisor-initiated pre-population, examples of which are described below, financial advisors or other professionals pre-populate client household data before clients access the system. This deployment model addresses the cold-start problem for household data collection by leveraging documents and information already assembled by advisors as part of their client relationships.

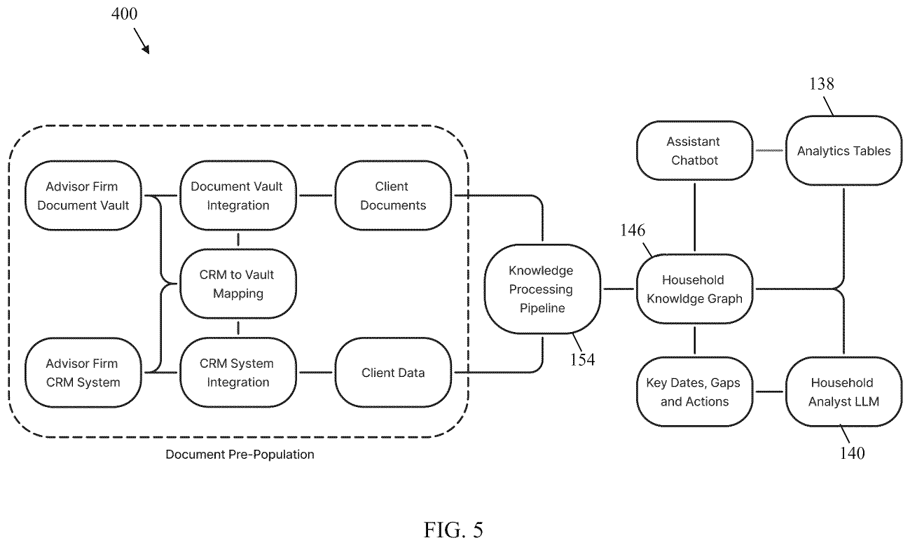

FIG. 5 illustrates one example of a B2B2C document pre-population workflow 400 in accordance with principles of the present disclosure, utilizing Ingestion Connectors 180 (FIG. 1) and Kete Integration APIs 172 (FIG. 1) to enable automated document retrieval from advisor systems. In some embodiments, advisor-initiated pre-population can occur through multiple input channels: (i) the Advisor Interface (web or mobile) enabling manual document upload; (ii) Advisor/Team Member Interface providing bulk upload capabilities; (iii) Direct integration to firm document vaults and CRM systems via Kete Integration APIs 172; (iv) 3rd Party Integration sources providing automated data feeds. Documents and data ingested through these channels enter the Knowledge Processing Pipeline 154 (FIG. 1) which comprises sequential processing stages: Ingest, Classify, Extract, Refine, and Process.

Upon completion of the Knowledge Processing Pipeline 154, extracted and refined data populates the Household Knowledge Graph 146, from which Analytics Tables 138 are generated, providing structured queryable data organized by household identifier. The populated household data becomes accessible through multiple interfaces: the Household Analyst LLM 140 for analytical queries and report generation, the Community Knowledge Graph for benchmarking and comparative analysis (with appropriate anonymization via Anonymization Engine 142 (FIG. 1)), External Connectors (APIs, Integrations) enabling bidirectional data synchronization with advisor systems, and 3rd Party Data Enrichment Connectors augmenting household data with external contextual information.

For advisors managing multiple client households at scale, the platform supports automated vault monitoring, examples of which are provided below. In some embodiments, the Kete Integration APIs 172 (FIG. 1) periodically poll advisor document vault systems via API connections, detecting newly added or modified documents associated with client households. The polling interval is configurable, with typical implementations checking for updates hourly or daily depending on advisor preferences and vault system capabilities. When new documents are detected, they are automatically ingested through the Knowledge Processing Pipeline 154 without requiring manual advisor intervention, maintaining up-to-date household data as clients share new information with their advisors through existing advisor-client workflows.

In some embodiments implementing customer relationship management (CRM) integration as described in greater detail below, household-level information and analytics are synchronized bidirectionally with advisor CRM systems. Changes to household data within the platform (such as updated account values, new insurance policies, or detected planning opportunities) are automatically pushed to corresponding client records in the advisor's CRM system. Similarly, updates to client information within the CRM (such as address changes, family status changes, or meeting notes) are pulled into the platform's household records, ensuring consistency across systems without requiring duplicate data entry.

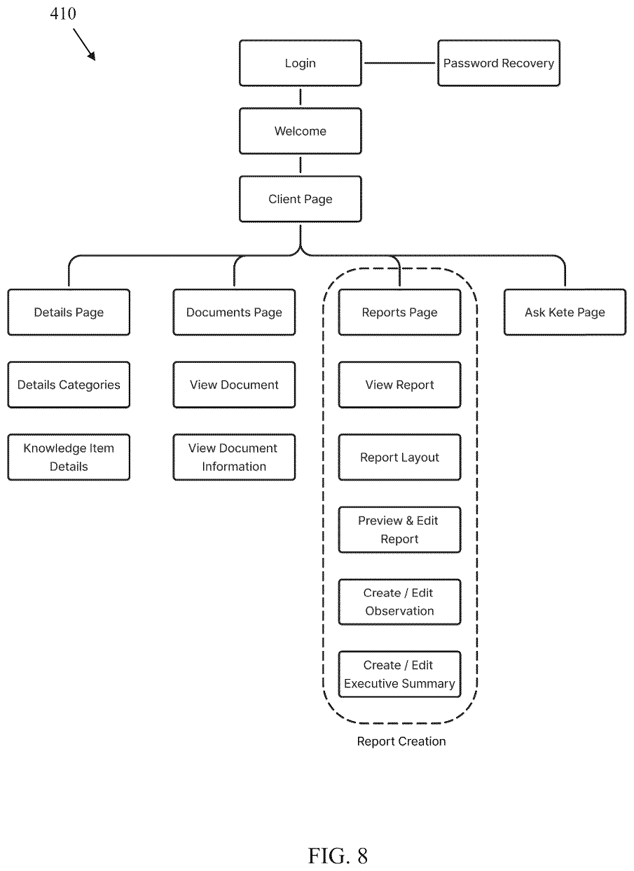

FIG. 8 illustrates an example advisor interface navigation 410 for B2B2C deployments. Advisors access the platform through a Login screen and proceed to a Welcome screen followed by a Client Page serving as the central navigation hub. From the Client Page, advisors can access: the Details Page and Details Categories for viewing and correcting client household information; the Documents Page and associated views (View Document, View Document Information) for document management; the Reports Page for accessing and generating holistic planning reports as described in FIG. 7, including View Report, Report Layout, Preview & Edit Report, Create/Edit Observation, and Create/Edit Executive Summary capabilities; and Ask Kete Page for conversational querying of client household data using natural language.

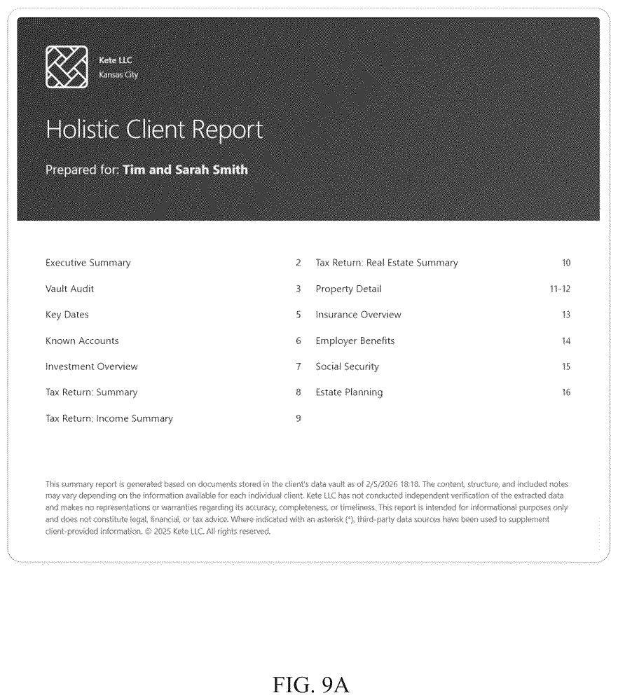

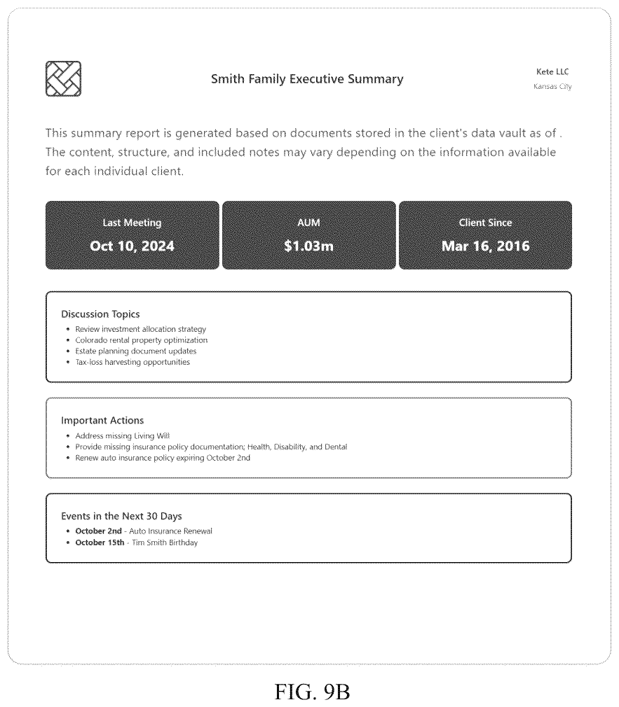

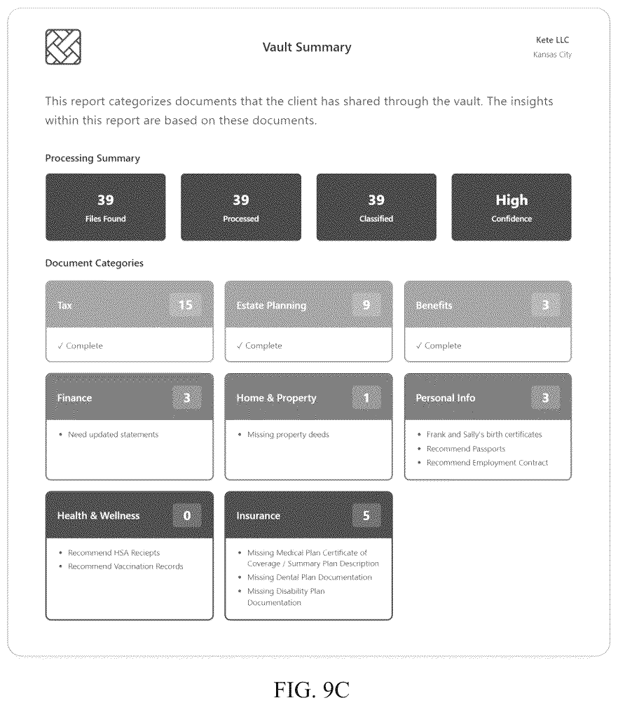

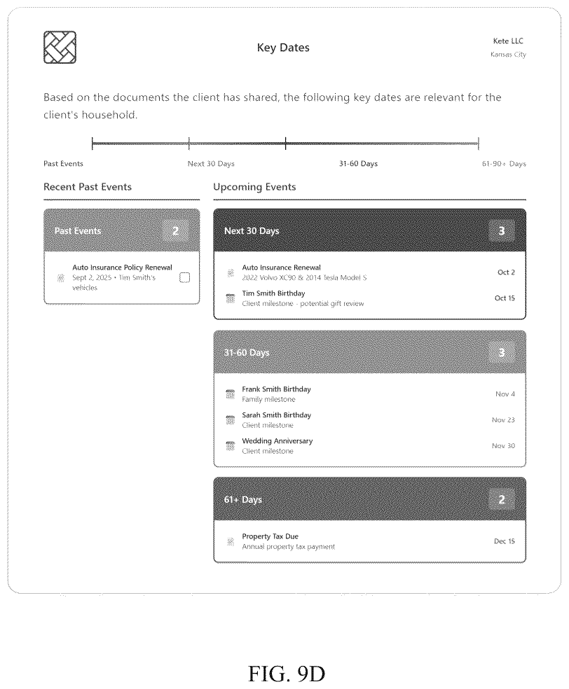

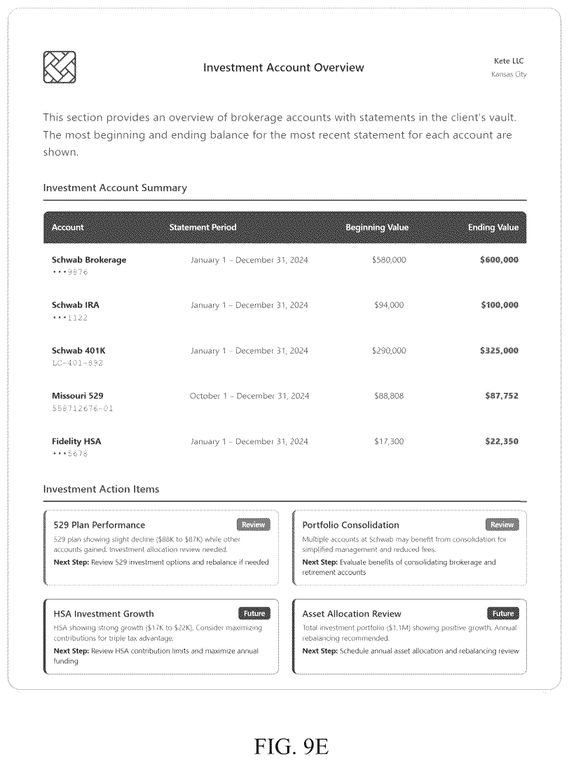

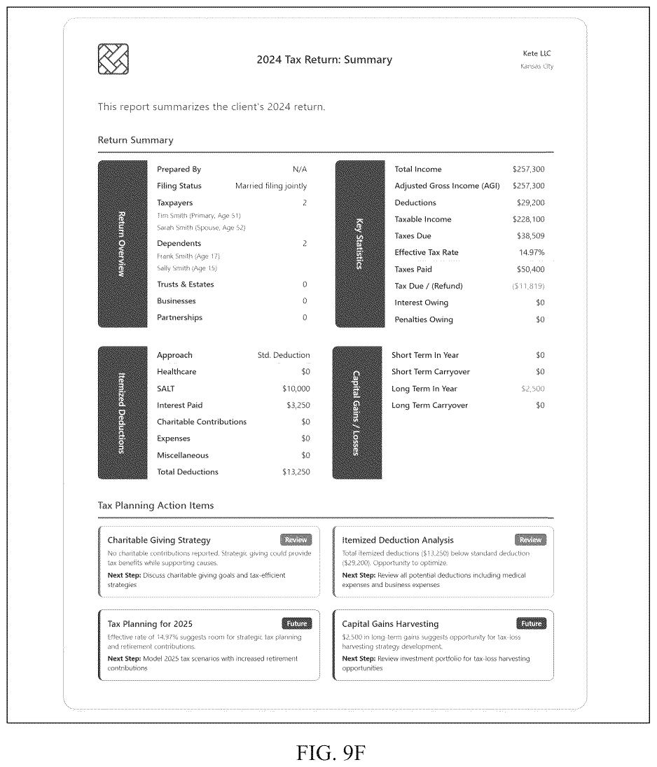

The report produced for advisors provides a detailed view of the client's household, supporting advisors in the delivery of holistic planning services, while also creating the rationale for the pre-population of client documents by the advisor for the client. The report is initially rendered in HTML and then converted to a print friendly, and immutable PDF file for the advisor. Reports can be produced either in the advisor's firms branding, or in Kete's branding as shown in the examples of FIG. 9A-9F. Reports combine an advisor configurable collection of report sections including; a dynamically compiled table of contents (FIG. 9A), an executive summary containing values drawn from the Advisor's CRM platform and the AI generated executive summary (FIG. 9B), a summary of the client's documents and gaps by holistic planning domain (FIG. 9C), a summary of recent and upcoming key dates (FIG. 9D), a summary of investment accounts (FIG. 9E), and of tax returns (FIG. 9F). Examples of AI generated observations appear on FIGS. 9E and 9F.

### Knowledge Processing Pipeline

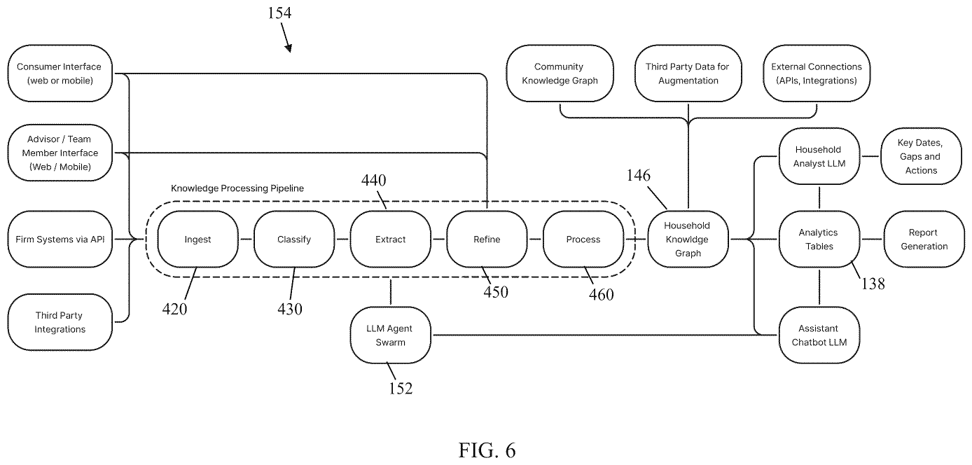

The Knowledge Processing Pipeline 154 (FIG. 1), illustrated in detail in FIG. 6, processes all incoming household data regardless of source (consumer upload, advisor upload, API connection, or manual data entry). The pipeline 154 comprises five sequential stages coordinated through an event queue that manages workflow state and provides resilience through failure isolation.

The Ingest stage 420 receives documents and data from multiple input channels: Consumer Interface (web or mobile applications), Advisor/Team Member Interface (B2B2C workflows), Advisor Systems via API (automated advisor system integration), and 3rd Party Integrations (financial data aggregators, insurance portals, government data sources). Ingested documents are encrypted and stored in the household's Documents repository 162 (FIG. 1) with metadata including upload source, timestamp, associated household identifier, and encryption status. Documents are assigned unique identifiers and queued for classification.

The Classify stage 430 applies document type classification using lightweight LLM models to assign each document to one of over 300 supported document types organized within eight primary knowledge domains (further examples of which are provided below): Personal Information (subcategories including Identification Documents, Contact Information, Family Records, Education History), Finance & Investment (subcategories including Brokerage Accounts, Retirement Accounts, Banking Accounts, Investment Holdings), Tax (subcategories including Federal Tax Returns, State Tax Returns, Tax Supporting Documents, Tax Planning Documents), Home & Property (subcategories including Real Estate, Vehicles, Valuables), Insurance (subcategories including Life Insurance, Auto Insurance, Homeowners Insurance, Umbrella Insurance, Health Insurance), Benefits (subcategories including Employment Benefits, Social Security, Third Party Benefits), Estate Planning (subcategories including Wills, Trusts, Powers of Attorney, Healthcare Directives, Beneficiary Designations), and Health & Wellness (subcategories including Medical Records, Prescriptions, Healthcare Providers, Fitness Records). Classification confidence scores are recorded, with low-confidence classifications flagged for manual review.

The Extract stage 440 applies Knowledge Type Templates to classified documents, wherein each template defines a structured JavaScript Object Notation (JSON) schema specifying the target data elements to extract for that document type. Extraction is performed by specialized agents within the LLM Agent Swarm 152, which generates a first set of vector representations corresponding to extracted structured data and a second set of vector representations corresponding to unstructured portions of the documents, the unstructured portions being segmented to retain contextual relationships. This approach significantly improves the platform's performance in terms of both the precision of answers and the ability to interpret the intent of user queries. For example, for a document classified as “Form 1040-Federal Tax Return,” the Extract stage applies a tax return knowledge type template that instructs extraction agents to identify and extract: filing status, total income, adjusted gross income, taxable income, federal tax paid, and other structured fields defined in the template schema. Extraction agents make parallel calls to appropriate LLM models via zero data retention APIs, with extraction results returned as JSON objects conforming to the template schema. Extracted data is written to staging tables in a first database transaction examples of which are provided below, providing failure isolation such that extraction failures do not prevent downstream processing of successfully extracted data from other documents, and detailed audit trails for information provenance.

The Refine stage 450 implements quality assurance validation of extracted data through specialized QA agents within the Agent Swarm. Refinement activities include: (i) validating extracted data against schema requirements and data type constraints; (ii) checking for internal consistency within extracted data (e.g., ensuring sum of income line items matches total income); (iii) automatically resolve inconsistencies based on a configurable hierarchy of document type trustworthiness for the knowledge item being extracted; (iv) establishing provenance metadata linking each extracted data point to specific locations within source documents, including page numbers, section identifiers, textual location within images, and extraction confidence scores; (v) detecting and resolving ambiguities or extraction errors through iterative LLM calls with refined prompts; and (vi) flagging items requiring human review when confidence thresholds are not met. Refinement updates occur in a second database transaction examples of which are provided below, updating staging data with validation results, provenance information, and confidence scores. This transactional separation ensures that partial refinement does not corrupt extracted data and enables progressive enrichment even when refinement of some data points fails.

The Process stage 460 maps refined, validated extraction results to specific entities and fields in the Household Knowledge Graph 146 and Analytics Tables 138. This deterministic mapping creates or updates structured records in domain-specific analytics tables, examples of which are provided below, optionally including one or more of: households table, household_members table, tax_returns table, accounts table, account_owners table, positions table, transactions table, properties table, insurance_policies table, income_sources table, liabilities table, documents table, and document_embeddings table. Each analytics table comprises a household_id foreign key enabling household-specific queries.

Process stage mapping occurs in a third database transaction, examples of which are provided below, ensuring that analytics table population failures do not corrupt staging data from Extract and Refine stages. This three-phase transactional structure provides failure isolation wherein: (i) failure of the Extract phase (first transaction) does not prevent execution of Refine and Process phases on other documents; (ii) failure of the Refine phase (second transaction) does not prevent execution of the Process phase using unrefined but structurally valid extracted data; and (iii) partial completion provides progressively richer analytics data, with households benefiting from whatever processing stages complete successfully even when later stages encounter errors.

Throughout all pipeline stages, the event queue manages workflow state, tracking which documents have completed which processing stages, queuing failed items for retry with exponential backoff, and providing a comprehensive audit trail of all processing activities, timestamps, and outcomes. This queue-based architecture enables horizontal scaling of processing capacity by adding additional worker nodes that consume events from the queue, and provides resilience by allowing failed processing attempts to be retried without losing workflow state or requiring reprocessing of successfully completed stages. Logging throughout the process ensures robust auditability for data provenance to support accuracy and compliance in regulated industries.

### Three-Phase Analytics Population

The analytics population process utilized with some embodiments of the present disclosure implements a three-phase approach providing progressively richer data through successive enrichment passes. This approach is embodied in the Process stage of the Knowledge Processing Pipeline and utilizes retrieval-augmented generation (RAG) techniques to extract nuanced information beyond simple field mappings.

Phase 1: Direct Field Mapping. The first phase applies direct mappings from extracted JSON data (or other format) to analytics table fields where straightforward correspondence exists. For example, when processing a Form 1040 federal tax return document that has been extracted per the knowledge type template, Phase 1 maps: extracted “filing_status” field→tax_returns. filing_status column; extracted “total_income” field→tax_returns. total_income column; extracted “adjusted_gross_income” field→tax_returns. adjusted_gross_income column; extracted “taxable_income” field→tax_returns. taxable_income column; extracted “federal_tax_paid” field→tax_returns. federal_tax_paid column. Phase 1 mappings are deterministic and require no LLM inference, providing an explicable baseline analytics dataset even if subsequent phases fail.

Phase 2: RAG-Based Enrichment. The second phase applies retrieval-augmented generation mappings stored in a configuration table, examples of which are provided below. In some embodiments, each RAG mapping defines: (i) a unique identifier; (ii) a name for the mapping; (iii) a querystring for vector similarity search against the document embeddings table; (iv) a target table specifying which analytics table to populate; (v) an extraction prompt providing instructions to the large language model; (vi) a table schema defining expected output structure and data types; (vii) validation rules for extracted data; and (viii) an active flag enabling or disabling the mapping. Other formats are also acceptable.

As provided below, each RAG mapping can execute in a temporary conversation context that is discarded after extraction, preventing cross-contamination between different extraction tasks. The LLM is instructed to return structured data conforming to the table schema. For example, a RAG mapping for extracting investment account details might define: querystring “investment account details brokerage retirement 401k IRA”, target table “accounts”, extraction prompt “Extract all investment account information including account name, institution, account type (brokerage/IRA/401k/other), account number (last 4 digits only for privacy), and approximate balance”, table schema defining fields and data types, validation rules ensuring account_type matches enumerated values.

When this RAG mapping executes, in some embodiments the system: (i) performs vector similarity search using the querystring against document embeddings in the document_embeddings table, retrieving the top K most semantically similar document chunks where K is typically 5-10 depending on context window constraints; (ii) constructs a prompt comprising the extraction prompt, table schema, retrieved document chunks, and instructions to return only valid JSON matching the schema; (iii) invokes an appropriate LLM model via zero data retention APIs; (iv) parses the returned JSON response; (v) validates against the table schema and validation rules; and (vi) inserts or updates records in the target analytics table (in this example, the accounts table). This process repeats for each active RAG mapping, progressively enriching the analytics tables with information not captured through Phase 1 direct mappings.

Phase 3: Cross-Document Synthesis. The third phase performs synthesis across multiple documents to, for example, identify relationships, detect contradictions, calculate derived metrics, and populate aggregate analytics as described in greater detail below. For example, Phase 3 synthesis for tax analytics can entail: (i) aggregating data extracted from federal tax return documents, wage and income documents (W-2, 1099 forms), investment income documents, and state tax return documents; (ii) applying synthesis logic to combine multiple tax forms into a single comprehensive tax_returns record per tax year per household; (iii) calculating derived metrics including effective tax rate (federal tax paid÷adjusted gross income) and marginal tax rate based on taxable income ranges and current tax bracket schedules; and (iv) populating the tax_returns table with synthesized annual tax data providing a complete household tax picture beyond what any single document contains.

Cross-document synthesis can also include contradiction detection, such that Phase 3 processing: (i) identifies related documents based on shared entities (e.g., all documents mentioning a specific bank account); (ii) detects contradictions across documents such as beneficiary designations on insurance policies not matching trust beneficiaries, account ownership information not matching estate planning documents, or income reported on tax returns not matching pay stub totals; (iii) generates alerts to users when contradictions are detected, providing specific details about conflicting information and source documents; and (iv) optionally may provide reconciliation interfaces enabling users to correct source data or confirm which document reflects current reality. This contradiction detection capability helps households and advisors identify outdated documents, inconsistent planning, and potential errors requiring attention.

The three-phase structure provides progressive enrichment with graceful degradation. Households receive immediate value from Phase 1 direct mappings even if network issues or LLM API failures prevent Phase 2 and Phase 3 execution. Phase 2 RAG enrichment provides deeper extraction when LLM APIs are available but can be skipped if Phase 1 data is sufficient for basic analytics. Phase 3 synthesis delivers the richest insights but depends on having multiple related documents processed through Phases 1 and 2, making it the least critical for initial household value delivery but the most valuable for holistic planning once sufficient household data has been collected.

### Conversational Interface and Rag Querying

The platform provides conversational querying capabilities through the Assistant Chatbot LLM 144 (FIG. 1) implementing retrieval-augmented generation as explained below. Users interact with the conversational interface through the “Ask Kete” feature accessible from the Primary Functions menu (FIG. 2) in consumer deployments and from the Ask Kete Page (FIG. 8) in advisor deployments.

When a user submits a natural language query, the conversational interface of some embodiments of the present disclosure: (i) receives queries in natural language from users or advisors; (ii) performs vector similarity search against document embeddings stored in the document_embeddings table, retrieving document chunks semantically related to the query; (iii) retrieves relevant data from analytics tables based on query intent and detected entities; and (iv) generates responses using a large language model with retrieved context from both document chunks and structured analytics data. The combination of unstructured document content (via embeddings) and structured analytics data (via database queries) provides comprehensive answers grounded in actual household information, and references stored documents as required.

For example, when a user asks “What is my effective tax rate for 2024?”, the system: (i) performs vector similarity search for “effective tax rate 2024 federal taxes” against document embeddings, potentially retrieving chunks from Form 1040, tax planning documents, and advisor communications; (ii) queries the tax_returns analytics table filtered by household_id and tax_year=2024, retrieving the calculated effective_tax_rate field populated during Phase 3 synthesis; (iii) constructs a prompt to the Assistant Chatbot LLM comprising the user's question, relevant document chunks, the tax_returns table data, and instructions to provide a clear answer citing specific sources; and (iv) returns a natural language response such as “Your effective tax rate for 2024 is 18.3%, calculated as $32,450 in federal tax paid divided by $177,200 in adjusted gross income. This is shown on your 2024 Form 1040 filed on Apr. 15, 2025 (optionally with a link to the document).”

In some embodiments, the conversational AI assistant of the present disclosure supports tool use for accessing household information, and can invoke functions to one or more of: (i) search documents by metadata (date ranges, document types, uploading party); (ii) query analytics tables with structured filters; (iii) retrieve specific knowledge units by identifier or knowledge type; (iv) calculate derived metrics on demand; and (v) generate visualizations of household data such as investment allocation charts or tax trend graphs. This tool use capability enables the conversational interface to perform computational tasks and data retrievals beyond simple text generation, providing interactive analytical capabilities.

In some embodiments, conversation memory is maintained within user sessions, enabling multi-turn dialogues where context from previous exchanges informs subsequent responses. For example, after asking “What is my effective tax rate for 2024?”, a user might follow up with “How does that compare to 2023?” The system maintains conversation history including the prior query and response, enabling it to understand that “that” refers to the 2024 effective tax rate and to retrieve comparative 2023 data without requiring the user to restate the complete question. Session-based conversation memory is ephemeral and does not persist between sessions, providing privacy and preventing outdated context from affecting future unrelated queries.

### Report Generation

The platform generates comprehensive holistic planning reports, for example as illustrated in FIG. 7. Reports can provide professional-grade documentation of holistic household context suitable for advisor-client planning meetings and household record-keeping, for example.

Report generation workflow in accordance with some embodiments comprises sequential stages managed through user interface controls (FIG. 8 Reports Page) that guide advisors or sophisticated consumers through report creation. The process begins with Report Sections generation in which the system populates verified data points from analytics tables into a plurality of report section templates. Each section template corresponds to a holistic planning domain such as Tax, Investments, Estate Planning, Insurance, or Benefits. Templates define the structure, required data points, and formatting for each section type.

In some embodiments, the systems and methods of the present disclosure generate observations for each report section by: (i) providing one or more LLM-based agents access to both the analytics tables and the vector database containing embedded document content; and (ii) prompting the LLM-based agents to analyze the data and generate contextual observations relevant to the holistic planning domain of each section. For example, for a Tax Planning section, the Reporting LLM 128 (FIG. 1) might generate observations such as: “Client's effective tax rate decreased from 19.2% in 2023 to 18.3% in 2024 primarily due to increased retirement plan contributions of $22,500 which reduced taxable income,” or “Client may benefit from tax-loss harvesting in the XYZ Technology Fund position which shows an unrealized loss of $8,400 according to the most recent brokerage statement dated October 15, 2025.”

In some embodiments, the systems and methods of the present disclosure generate an executive summary by: (i) providing an LLM-based agent access to key dates and observations from across the plurality of sections; and (ii) prompting the LLM-based agent to synthesize cross-domain insights. The executive summary identifies overarching themes, high-priority action items, and coordination opportunities across multiple holistic planning domains. For example, the executive summary might note: “Client is well-positioned for retirement from an investment perspective with $1.8M in retirement accounts, but estate planning documents have not been updated since 2018 and do not reflect recent changes in family structure. Priority actions include updating beneficiary designations and establishing a revocable living trust.”

Following generation of sections and executive summary, the system transitions to the Compiled Report stage wherein all selected sections are assembled into a cohesive document structure. The user then enters the Edit Report stage where they can review and modify content. In some non-limiting examples, the user can: (i) edit existing observations and executive summary generated by the LLM; (ii) add new content based on their professional judgment or knowledge of circumstances not reflected in the data; or (iii) delete content that is irrelevant or incorrect. The system tracks a Revisions History of all modifications including original LLM-generated content, generating agent identifier, modified content, user identifier making the modification, and modification timestamp, providing full audit trail of human-in-the-loop editing.

Upon completion of editing, the user finalizes the report, transitioning to the Final Report stage. In some embodiments, the finalized report is rendered as an immutable PDF document available for download. The PDF includes selected sections only (user chooses which sections to include during compilation stage), preserving formatting, observations and the executive summary as finalized by the user. The system can, in some embodiments, maintain provenance metadata for each data point in the report, such as: source document identifier, location within the source document (page number, field name, or document section), extraction timestamp, and extraction confidence score. This provenance metadata enables traceability of every factual assertion in the report back to underlying source documents, supporting audit requirements and regulatory compliance.

FIGS. 9A-9F illustrate representative examples of generated holistic reports showing report layout, section structure, and the integration of verified data points with LLM-generated observations and analysis. Reports present household information in professional formatting, combining quantitative data from analytics tables with qualitative insights generated by the Reporting LLM.

### Additional Features

The platforms, systems and methods of the present disclosure optionally incorporate additional features supporting household management beyond core data collection, processing, and querying capabilities.

Benchmarking and Comparative Analytics. The Anonymization Engine 142 FIG. 1) can be configured or programmed to aggregate data across multiple household knowledge graphs to generate anonymized benchmarks. For example, households can compare their effective tax rate, investment allocation, insurance coverage ratios, or retirement savings rate against anonymized cohorts of similar households (matched by income level, age, geography, or other factors). The Community Knowledge Graph 134 (FIG. 1) stores these aggregated, anonymized insights. Benchmarking queries utilize the anonymized data to provide context such as “Your effective tax rate of 18.3% is in the 60th percentile for households in your income range, meaning 40% of similar households pay higher effective tax rates.” Individual household data is never disclosed; only aggregate statistical measures are computed and shared.

Workflow Automation and Life Event Templates. The platform includes Life Event Workflow Templates 130 (FIG. 1) that structure data collection and action sequences around major household transitions such as marriage, divorce, birth of a child, home purchase, job change, or retirement. When a user indicates a life event, or the platform detects a pattern of data suggesting an event, the corresponding workflow template can activate, prompting collection of relevant information, recommending required documents, and generating domain-specific action items. For example, upon indication of a new child birth event, the platform generates actions to: obtain birth certificate, add child to health insurance, update estate planning beneficiaries, consider increasing life insurance coverage, and establish 529 education savings account. Use Case Templates 158 (FIG. 1) similarly group knowledge types into pre-defined sets facilitating efficient data collection for specific planning purposes.

Third-Party Integration and Data Enrichment. In some embodiments, ongoing household data population includes API connections to third-party systems and optional data enrichment from external sources. The platform optionally supports connections to financial data aggregators (such as Plaid, Yodlee, or Finicity) enabling automated synchronization of bank account balances, investment positions, and transaction histories. Insurance policy data can be automatically updated through carrier APIs. 3rd Party Data Enrichment Connectors 178 (FIG. 1) augment household data with contextual information such as real estate valuations, securities pricing, etc. These enrichments occur automatically in the background, with the Knowledge Processing Pipeline processing API-provided data through the same Extract-Refine-Process stages used for document processing.

Audit Trail and Change Tracking. In some embodiments, all modifications to household data, permissions changes, document uploads, and system actions are logged with timestamps, user identifiers, and change details. Where provided, this comprehensive audit trail supports compliance requirements for advisors and firms operating under fiduciary standards and provides households with transparency into how their data has been accessed and modified over time. In some non-limiting examples, report generation specifically tracks provenance metadata and modification history, ensuring traceability and accountability for planning recommendations.

### Multi-household Management and Encryption

In some embodiments, the systems and methods of the present disclosure support management of a plurality of distinct households, each household having independent encryption keys in the B2C modality, separate analytics data, and configurable contributor permissions. Where a deployment is made through a B2B2C modality, the firm has the option of selecting either a firm level encryption key, or independent encryption keys per household. In both modalities a single user can manage multiple households simultaneously.

In some examples, each household is assigned a unique household_id that serves as the primary organizational key throughout the system. All analytics tables include household_id as a foreign key, enabling efficient household-specific queries that retrieve only data belonging to a single household. Database-level access controls enforce that queries cannot retrieve data from households the requesting user does not have permission to access. B2B2C implementations are deployed to separate cloud projects, providing further physical separation of household data.

Each household's documents and sensitive data are encrypted using a unique encryption key derived from a master key using the household_id as a key derivation input. This ensures that compromise of one household's encryption key does not enable decryption of other households' data. Encryption keys are managed through a secure key management system with hardware security module (HSM) backing in production environments. Where a deployment is made through a B2B2C modality, the firm has the option of selecting either a firm level encryption key, or independent encryption keys per household. Other encryption techniques are also acceptable.

Users can have different permission levels across multiple households. For example, a user might have full administrative permissions for their own primary household, read-only permissions for their elderly parent's household where they serve as an authorized viewer, and collaborative permissions for a blended household they co-manage with a spouse. Permission grants are stored in the Permissions table 150 (FIG. 1) with granular controls over access to specific documents, knowledge units, or analytics data within each household.

The multi-household architecture can, in some embodiments, support common scenarios including: (i) individuals managing their nuclear family household while also accessing an aging parent's household to assist with affairs; (ii) blended families where ex-spouses maintain separate primary households but share a household for children's information (education savings, insurance, etc.); (iii) high-net-worth individuals managing multiple households for different family branches or trusts; and (iv) financial advisors in B2B2C deployments accessing hundreds or thousands of client households through the advisor interface, with appropriate permissions granted by each client household.

### Alternative Embodiments and Variations

Document processing variations. While some of the described embodiments implement a five-stage pipeline (Ingest, Classify, Extract, Refine, Process), alternative embodiments can merge stages (e.g., combining Extract and Refine) or add additional stages (e.g., separate Translation stage for non-English documents). The three-phase analytics population (direct mapping, RAG enrichment, cross-document synthesis) can be implemented with different transactional boundaries or as a single atomic transaction in embodiments where failure isolation is less critical. Alternative RAG approaches can use different vector search algorithms, different embedding models, or different retrieval strategies such as hybrid search combining semantic similarity with keyword matching.

LLM agent variations. While some of the described embodiments use multiple specialized LLM models accessed via zero data retention APIs, alternative embodiments can: (i) use a single general-purpose LLM for all tasks with different system prompts; (ii) host LLM models locally within the platform infrastructure rather than accessing external APIs; (iii) fine-tune open-source LLM models on domain-specific document types to improve extraction accuracy; and/or (iv) use ensemble approaches wherein multiple LLMs process the same document and results are aggregated through voting or confidence-weighted averaging.

Integration variations. While specific integration points are described (vault monitoring, CRM synchronization, financial data aggregators), alternative embodiments can integrate with different external systems including: (i) tax preparation software for bidirectional exchange of tax data; (ii) estate planning platforms for synchronization of trust and beneficiary information; (iii) insurance carrier portals for real-time policy status updates; (iv) government benefit systems for Social Security, Medicare, or veterans benefits data; and/or (v) healthcare systems for synchronization of medical records and insurance claims data. The Integration Connectors 170 (FIG. 1) and Kete Integration APIs 172 (FIG. 1) provide extensible frameworks for adding new integration types.

Analytics variations. While specific analytics tables are described (tax_returns, accounts, positions, etc.), alternative embodiments can implement different table structures, denormalized data models for query performance, or graph database backends instead of relational databases. The household_id organizational principle remains central regardless of underlying data model. Alternative embodiments might compute different derived metrics, apply different domain-specific synthesis rules, or implement machine learning models trained to predict future household needs based on historical patterns in the knowledge graph.

### Aspects

Various aspects in accordance with principles of the present disclosure are described below. It is to be understood that any one or more of the features recited in the following Aspect(s) can be combined with any one or more of other Aspect(s).

Aspect 1. A computer-implemented method for managing household information through multi-source data ingestion and intelligent processing, comprising:
A. performing initial household data population using at least one of:
   i. firm-initiated pre-population wherein a third party with domain knowledge (e.g., a third party expert or system providing advisory service on subject matter such as financial, medical, technical, etc.) provides existing client documents, thereby pre-populating the household's knowledge base prior to the consumer's first interaction with a consumer-facing application, through at least one of:
      a. automated connection to the firm's document vault system, wherein the connection is paired to a client record in a customer relationship management system, and wherein the system automatically monitors the document vault for new or changed documents associated with the client record and retrieves them without manual intervention,
      b. bulk document upload from the firm's document management system,
   ii. consumer-initiated population wherein a consumer uses a consumer-facing application interface, comprising:
      a. guided discovery workflows presenting domain-specific questionnaires organized by household management domains that can include, but are not limited to, one or more of: Personal Information, Finance & Investment, Tax, Home & Property, Insurance, Benefits, Estate Planning, and Health & Wellness, wherein questionnaires apply cognitive chunking by grouping related items within a knowledge domain to aid recall,
      b. attention management by immediately capturing easily recallable data within discovery workflows and creating deferred action items for data requiring documentation to be completed outside the workflow,
      c. gamification mechanics comprising progress indicators, level progression, achievement badges, and visual, audio, or haptic feedback to motivate sustained engagement,
      d. immediate value demonstrations displaying extracted information, identified upcoming dates, and generated insights from each uploaded document to reinforce data collection behavior,
B. receiving ongoing data inputs from a plurality of supplementary input sources, wherein the supplementary input sources may comprise any combination of:
   i. application programming interface (API) connections to one or more firm systems providing automated data retrieval, wherein firm systems may comprise customer relationship management systems, financial planning software, custodian platforms, brokerage systems, tax preparation software, insurance portals, and document management systems, wherein data is automatically retrieved according to predefined data schemas,
   ii. consumer-facing application interface providing conversational interactions with a chat interface wherein facts stated during conversation are extracted and flagged for documentation, document upload capabilities, and form submission capabilities,
   iii. in business-to-business-to-consumer configurations, an advisor-facing portal interface enabling financial advisors to upload documents, correct extracted information, produce holistic reports and search within and across knowledge items for client households,
   iv. collaborative inputs from one or more team members associated with a household, wherein each team member accesses the system through the consumer-facing application or advisor-facing portal according to assigned role-based permissions,
   v. third-party data provider connections enabling automated retrieval of household-related information through consumer-authorized integrations or platform-integrated data enrichment services;
C. for each received data input, recording provenance metadata including one or more of:
   i. an input source identifier indicating which input source provided the data,
   ii. a contributing user identifier or system identifier,
   iii. a timestamp of receipt,
   iv. an authentication status, and
   v. a data quality indicator;
D. applying a multi-stage processing pipeline to each document comprising:
   i. encrypting the document using a household-specific, or firm specific, encryption key,
   ii. classifying the document into a hierarchical taxonomy comprising a category, a sub-category, and a specific document type by comparing document content against predefined classification criteria,
   iii. extracting structured data using a document-type-specific extraction schema defining fields to extract, entity patterns, attribute patterns, and date patterns,
   iv. generating embeddings at two levels:
      a. a full-document embedding representing entire document content, and
      b. a plurality of chunk-level embeddings each representing a document portion with position metadata,
   v. storing extracted structured data and embeddings in a household-centric data model wherein all data is associated with a household identifier;
E. executing a three-phase analytics population process comprising:
   i. a first phase mapping extracted data directly to analytics tables using predefined field path expressions,
   ii. a second phase applying retrieval-augmented generation by:
      a. performing vector similarity search using document embeddings,
      b. retrieving relevant document chunks as context,
      c. submitting extraction prompts to a large language model with retrieved context to extract additional structured data,
   iii. a third phase synthesizing relationships across multiple documents by applying a large language model to identify connections, discrepancies, and aggregated insights;
F. populating a plurality of domain-specific analytics tables organized by planning category, wherein each analytics table comprises records associated with household identifiers enabling retrieval of all information for a specific household;
G. identifying action items and key dates from the populated analytics tables, wherein action items comprise at least one of: upcoming renewal dates, missing documentation, insurance coverage gaps, tax optimization opportunities, or estate planning document expirations;
H. generating automated reminders to users via the consumer-facing application based on the identified action items and key dates, thereby creating a continuous data collection cycle wherein:
   i. reminders prompt users to upload new documents or provide updated facts,
   ii. new inputs feed into the processing pipeline,
   iii. analytics tables are continuously updated,
   iv. new insights and reminders are generated;
I. providing a conversational interface that applies retrieval-augmented generation by:
   i. receiving natural language queries from users or advisors,
   ii. performing vector similarity search against document embeddings,
   iii. retrieving relevant document chunks and analytics data,
   iv. generating responses using a large language model with retrieved context,
   v. providing links to referenced documents stored on the platform;
J. generating comprehensive reports by:
   i. querying all analytics tables for a specified household,
   ii. calculating derived metrics spanning multiple domains,
   iii. identifying planning opportunities and action items,
   iv. rendering reports in at least one format selected from: HTML or PDF;
K. wherein the method supports flexible deployment configurations comprising:
   i. business-to-consumer configurations wherein initial population utilizes consumer-initiated information collection and ongoing inputs comprise consumer application interface and optionally API connections and team member inputs,
   ii. business-to-business-to-consumer configurations wherein initial population utilizes advisor-initiated pre-loading of documents and ongoing inputs comprise any combination of API connections, consumer application interface, advisor portal interface, and team member inputs,
   iii. hybrid configurations wherein a consumer-initiated household subsequently grants advisor access; and
L. wherein the method supports management of a plurality of distinct households, each household having independent encryption keys, separate analytics data, and configurable contributor permissions, and wherein a single user can manage multiple households simultaneously.

Aspect 2. The method of Aspect 1, wherein automated connection to the advisor's document vault system comprises:
A. establishing an application programming interface connector to a document management system providing cloud-based or on-premises document storage, retrieval, and version control capabilities;
B. authenticating the connector using secure authentication protocols;
C. receiving a mapping between client records in the advisor's customer relationship management (CRM) system and household identifiers in the system, wherein the mapping is created by:
   i. the advisor selecting a client from their customer relationship management system,
   ii. the system creating or identifying a corresponding household record,
   iii. storing the association between CRM client identifier and household identifier;
D. monitoring the document vault by:
   i. periodically polling the document vault API for document changes,
   ii. subscribing to event notification mechanisms when the vault supports real-time updates,
   iii. filtering documents based on client-specific folders, tags, or metadata;
E. upon detecting new or modified documents associated with a mapped client:
   i. automatically retrieving the document via the API,
   ii. recording provenance metadata including: vault system identifier, document path, last modified timestamp, file size,
   iii. processing the document through the multi-stage pipeline,
   iv. updating analytics tables with extracted data,
   v. generating notifications confirming successful ingestion, thereby maintaining current household data without requiring manual document upload operations.

Aspect 3. The method of Aspect 1 or 2, wherein pairing the client record in the advisor's customer relationship management system to the household identifier further comprises:
A. retrieving client metadata from the CRM system including client name, contact information, advisor assignment, client status, and custom fields;
B. automatically populating household profile fields using CRM metadata;
C. establishing a bidirectional synchronization wherein:
   i. changes to client status in the CRM trigger corresponding updates in the household record,
   ii. household completeness scores and key dates are pushed back to custom fields in the CRM for advisor visibility;
D. enabling the advisor to view household analytics directly within their CRM interface via embedded widgets or links.

Aspect 4. The method of any of Aspects 1-3, wherein ongoing automated monitoring, comprises:
A. detecting when advisors (or clients) add new documents to client folders;
B. automatically ingesting documents within minutes to hours of advisor upload to their vault;
C. processing new documents and updating analytics tables without manual intervention; and
D. optionally generating notifications to the consumer and/or advisor when significant new information is available, such as:
   i. notification that a team member uploaded an updated tax return with link to updated tax summary,
   ii. notification that new estate planning documents detected with prompt to review beneficiary changes.

Aspect 5. The method of any of Aspects 1-4, wherein the API connections to firm systems comprise connector interfaces providing standardized methods for data exchange, wherein each connector interface defines:
A. authentication methods;
B. data retrieval endpoints;
C. data transformation schemas mapping external data formats to internal knowledge type templates; and
D. synchronization schedules.

Aspect 6. The method of any of Aspects 1-5, wherein the firm systems comprise at least one of:
A. customer relationship management systems providing client contact information, interaction history, relationship assignment, and client status tracking;
B. financial planning software providing comprehensive plan data, goals, recommendations, and scenario analyses;
C. financial custodian platforms providing account balance information, investment holdings, transaction history, and performance data;
D. brokerage systems providing trade execution data, order status, and portfolio valuations;
E. tax preparation software providing completed tax returns, supporting schedules, and tax planning projections;
F. accounting software providing general ledger data, accounts payable/receivable, and financial statements;
G. insurance management platforms providing policy information, coverage details, premium schedules, and claims history;
H. document management systems providing secure document storage, version control, and retrieval capabilities; and
I. custom integrations via RESTful APIs providing data in structured formats such as JSON or XML.

Aspect 7. The method of any of Aspects 1-6, wherein conversational fact extraction comprises:
A. monitoring chat messages for factual statements;
B. applying natural language processing to identify entities, dates, amounts, and relationships;
C. generating inferred knowledge items from extracted facts;
D. flagging inferred items with a confidence score and a documentation required status; and
E. creating action items prompting users to upload supporting documentation.

Aspect 8. The method of Aspect 7, wherein conversational fact extraction further comprises:
A. detecting contradictions between stated facts and existing analytics data;
B. generating clarification prompts when contradictions are detected;
C. updating analytics data when users confirm facts supersede prior data; and
D. maintaining an audit trail of data corrections and their sources.

Aspect 9. The method of any of Aspects 1-8, further comprising at least one role-specific permission selected from the group consisting of:
A. for household member role: permission to view all data, upload documents, and answer questionnaires;
B. for spouse role: permission to view and edit all household data;
C. for financial advisor role: permission to view all data, upload documents, generate reports, and access advisor portal;
D. for certified public accountant role: permission to view tax-related data and upload tax documents;
E. for attorney role: permission to view estate planning and legal documents; and
F. for family member with power of attorney role: permission to view and edit specified categories of data based on POA scope.

Aspect 10. The method of any of Aspects 1-9, wherein the document-type-specific extraction schema is stored as a structured definition in a document types table comprising:
A. a category field defining top-level classification;
B. a sub-category field defining mid-level classification;
C. a doc-type-name field defining specific document type;
D. a structured field definition specifying fields to extract;
E. entity extraction patterns defining named entity recognition rules;
F. attribute extraction patterns defining attribute identification rules;
G. date extraction patterns defining date recognition rules; and
H. mapping definitions defining direct mappings to analytics table columns via field path expressions.

Aspect 11. The method of any of Aspects 1-10, wherein the hierarchical taxonomy comprises at least the following categories, wherein the taxonomy is extensible to support additional categories based on household needs and market requirements:
A. Personal Information comprising sub-categories such as: Identification Documents, Contact Information, Family Records, Education History;
B. Finance & Investment comprising sub-categories such as: Brokerage Accounts, Retirement Accounts, Banking Accounts, Investment Holdings;
C. Tax comprising sub-categories such as: Federal Tax Returns, State Tax Returns, Tax Supporting Documents, Tax Planning Documents;
D. Home & Property comprising sub-categories such as: Real Estate, Vehicles, Valuables;
E. Insurance comprising sub-categories such as: Life Insurance, Auto Insurance, Homeowners Insurance, Umbrella Insurance, Health Insurance;
F. Benefits comprising sub-categories such as: Employment Benefits, Social Security, Third Party Benefits;
G. Estate Planning comprising sub-categories such as: Wills, Trusts, Powers of Attorney, Healthcare Directives, Beneficiary Designations; and
H. Health & Wellness comprising sub-categories such as: Medical Records, Prescriptions, Healthcare Providers, Fitness Records.

Aspect 12. The method of any of Aspects 1-11, wherein the three-phase analytics population process executes as three separate database transactions such that:
A. failure of the first phase does not prevent execution of the second and third phases;
B. failure of the second phase does not prevent execution of the third phase;
C. partial completion provides progressively richer analytics data.

Aspect 13. The method of any of Aspects 1-12, wherein the second phase applies a plurality of retrieval-augmented generation mappings stored in a configuration table, each mapping defining:
A. a unique identifier;
B. a name for the mapping;
C. a querystring for vector similarity search;
D. a target table specifying which analytics table to populate;
E. an extraction prompt providing instructions to the large language model;
F. a table schema defining expected output structure and data types;
G. validation rules for extracted data; and
H. an active flag enabling or disabling the mapping.

Aspect 14. The method of Aspect 13, wherein each RAG mapping executes in a temporary conversation context that is discarded after extraction, preventing cross-contamination between different extraction tasks, and wherein the large language model is instructed to return structured data conforming to the table schema.

Aspect 15. The method of any of Aspects 1-14, wherein the domain-specific analytics tables comprise at least one of:
A. a households table storing household-level information;
B. a household members table storing individual member information;
C. a tax returns table storing annual tax data;
D. an accounts table storing financial account information;
E. an account owners table linking individuals to accounts;
F. a positions table storing investment holdings;
G. a transactions table storing financial transactions;
H. a properties table storing real estate information;
I. an insurance policies table storing insurance coverage information;
J. an income sources table storing employment and income data;
K. a liabilities table storing debt and loan information;
L. a documents table storing document metadata;
M. a document embeddings table storing vector embeddings, wherein each analytics table comprises a household id foreign key enabling household-specific queries.

Aspect 16. The method of any of Aspects 1-15, wherein generating chunk-level embeddings comprises:
A. segmenting each document into chunks using a sliding window approach with overlap percentage;
B generating a separate embedding vector for each chunk using a transformer-based language model; and
C. storing each chunk embedding with metadata comprising: chunk position, chunk length, page number, parent document id, and document type, wherein retrieving relevant chunks during RAG queries comprises:
   i. computing cosine similarity between query embedding and all chunk embeddings,
   ii. retrieving top-k chunks where k is a configurable variable,
   iii. ranking chunks by similarity score and recency.

Aspect 17. The method of any of Aspects 1-16, wherein the guided discovery workflows apply cognitive chunking by:
A. organizing questionnaires into domain-specific categories corresponding to knowledge type templates;
B. presenting questions within a single domain in a single session to leverage memory association;
C. displaying progress indicators showing completion percentage within each domain; and
D. allowing users to complete domains in any order based on their priorities.

Aspect 18. The method of Aspect 17, wherein applying attention management comprises:
A. for each question in the discovery workflow, providing user interface options comprising:
i. a first option to provide an immediate answer if easily recallable,
   ii. a second option to indicate “I need to check documents” which creates a deferred action item,
   iii a third option to indicate “Not applicable to my household” which skips the question; and
B. wherein deferred action items are added to a prioritized task queue accessible from a dedicated action items interface.

Aspect 19. The method of any of Aspects 1-18, wherein generating financial planning reports comprises:
A. populating verified data points from the analytics tables into a plurality of report section templates, wherein each section template corresponds to a holistic planning domain;
B. generating observations for each of the plurality of sections by: providing one or more LLM-based agents access to both the analytics tables and the vector database containing embedded document content, prompting the one or more LLM-based agents to analyze the data and generate contextual observations relevant to the holistic planning domain of each section;
C. generating an executive summary by:
   i. providing an LLM-based agent access to key dates and observations from across the plurality of sections,
   ii. prompting the LLM-based agent to synthesize cross-domain insights, receiving user selection of one or more sections to include in a finalized report,

D. receiving user modifications to the observations and executive summary prior to finalizing the report, wherein the user modifications comprise at least one of: editing existing observations, adding new observations, or deleting observations;

E. rendering the finalized report comprising only the selected sections in an immutable PDF for download;

F. maintaining provenance metadata for each data point in the report, wherein the provenance metadata comprises: source document identifier, location in the source document, extraction timestamp, and extraction confidence;

G. tracking all user modifications to the report, wherein the tracking comprises: original LLM-generated content, generating agent, modified content, user identifier, modification timestamp; and

H. storing the provenance metadata and modification tracking for audit purposes.

Aspect 20. The method of any of Aspects 1-19, wherein cross-document synthesis in the third phase comprises:
A. identifying related documents based on shared entities;
B. detecting contradictions across documents such as:
   i. beneficiary designations on insurance policies not matching trust beneficiaries,
   ii. account ownership information not matching estate planning documents,
   iii. income reported on tax returns not matching pay stub totals;
C. generating alerts to users when contradictions are detected; and
D. providing reconciliation interfaces enabling users to correct source data or confirm which document reflects current reality.

Aspect 21. The method of any of Aspects 1-20, wherein the method supports multi-household management by:
A. enabling a single user account to be associated with multiple households;
B. providing a household selector interface enabling users to switch between households;
C. maintaining separate encryption keys, analytics data, and permissions for each household; and
D. wherein switching between households updates the context for all queries, uploads, and analytics displays to reflect the currently selected household.

Aspect 22. The method of any of Aspects 1-21, wherein encryption comprises at least one of:
A. in business-to-consumer configurations: generating a unique encryption key for each household, encrypting all household data using the household-specific key;
B. in business-to-business-to-consumer configurations: generating encryption keys at a granularity level selected from:
   i. firm-level encryption wherein a single key encrypts data for all households managed by the financial advisor's firm,
   ii. household-level encryption wherein each household has a separate key,
   iii. wherein the granularity level is configurable based on the advisor firm's security and operational requirements; and
C. for each document:
   i. generating a symmetric encryption key,
   ii. encrypting the document content with the symmetric key,
   iii. encrypting the symmetric key with the selected encryption key,
   iv. storing both the encrypted document and encrypted symmetric key,
   v. wherein decryption requires access to the appropriate encryption key managed through a secure key management service.

Aspect 23. The method of any of Aspects 1-22, wherein in business-to-business-to-consumer configurations, collaborative inputs from team members comprise:
A. providing a team management interface enabling the household primary user to:
   i. invite team members by email address,
   ii. assign roles to each team member,
   iii. configure permissions by selecting which data categories each team member can access,
   iv. set time-limited access periods after which permissions automatically expire,
   v. revoke access at any time;
B. notifying invited team members via email with secure login credentials;
C. providing team members with a dedicated interface showing only data they have permission to access; and
D. tracking team member contributions with audit trails.

Aspect 24. The method of any of Aspects 1-23, further comprising:
A. aggregating and anonymizing household data across a plurality of households by:
   i. de-identifying data to remove personally identifiable information,
   ii. storing anonymized data in a community knowledge graph,
   iii. calculating benchmark metrics based on anonymized data; and
B. providing benchmark comparisons for households by:
   i. identifying comparable anonymized households based on demographic or other characteristics,
   ii. computing percentile rankings for household metrics,
   iii. displaying comparative insights within reports or the user interface.

Aspect 25. The method of Aspect 23 or 24, wherein tracking team member contributions further comprises:
A. recording access logs for each team member comprising:
   i. which documents were viewed,
   ii. which analytics data was accessed,
   iii. timestamps of access,
   iv. duration of access; and
B. generating access reports showing team member activity.

Aspect 26. The method of any of Aspects 1-25, further comprising:
A. providing life event workflow templates comprising:
   i. predefined sequences of action items for common life events,
   ii. template types including: moving home, preparing tax filing, retirement planning, estate planning updates,
   iii. automatically instantiating workflow steps upon detecting life event triggers in documents or conversations; and
B. tracking workflow completion status and sending progressive reminders.

Aspect 27. A system for managing household information, comprising:
A. a processor;
B. a memory storing:
   i. user authentication data structures,
   ii. household identification data structures,
   iii. document metadata and classification data structures,
   iv. vector embedding data structures for full documents and chunks,
   v. a plurality of domain-specific analytics data structures organized by holistic planning categories, each linked to household identifiers,
   vi. configuration data structures for retrieval-augmented generation,
   vii. team member and permission data structures,
   viii. action item and reminder data structures,
   ix. executable instructions;
C. a vector database supporting cosine similarity search operations on high-dimensional embedding vectors;
D. a large language model interface configured to receive context and generate structured extractions and natural language responses;
E. a plurality of API connectors providing interfaces to external firm systems; and
F. wherein the processor executes the instructions to perform a method, for example, but not limited to, the method of any of Aspects 1-26.

Aspect 28. The system of Aspect 27, wherein the vector database supports cosine similarity operations on high-dimensional embedding vectors, enabling efficient similarity search across millions of document chunks.

Aspect 29. The system of Aspect 27 or 28, wherein the API connectors comprise modular connector interfaces implemented as:
A. software packages providing standardized connection interfaces;
B. configuration files defining authentication parameters and endpoints;
C. data transformation modules mapping external schemas to internal knowledge type templates; and
D. synchronization schedulers triggering automated data retrieval.

Aspect 30. A non-transitory computer-readable medium storing instructions that, when executed by a processor, cause the processor to perform the method of any of Aspects 1-26.

Aspect 31. The non-transitory computer-readable medium of Aspect 30, wherein the instructions are organized into modules comprising:
A. an ingestion module handling inputs from multiple sources;
B. a classification module applying document taxonomy;
C. an extraction module applying document-type-specific schemas;
D. an embedding generation module creating dual-level vectors;
E. an analytics population module executing three-phase process;
F. a knowledge graph module maintaining household data relationships;
G. a reminder engine module generating automated notifications;
H. a conversational AI module handling natural language queries; and
I. a report generation module creating holistic planning reports.

The computer-implemented methods of the present disclosure operate through one or more algorithms, models, or computational processes. The platforms and software applications of the present disclosure can be programmed or formatted to operate on one or more computing devices that include a processor coupled to one or more memories. The processor can be a microprocessor, an embedded microprocessor, an embedded controller, a digital signal processor (DSP), or other computational unit. The processor is configured to execute program code stored in memory (e.g., registers, cache, random-access memory, read-only memory, EEPROM, flash memory, or combinations thereof). The program code, when executed by the processor, causes the processor to implement the various functions described herein. The processor can reside in any suitable computing equipment such as personal computers, laptops, tablets, mobile electronic devices (e.g., smartphones), servers, or cloud-based computational platforms distributed across multiple physical locations

Although the present disclosure has been described with reference to preferred embodiments, workers skilled in the art will recognize that changes can be made in form and detail without departing from the spirit and scope of the present disclosure.

What is claimed is:

1. A computer-implemented method for managing household information through multi-source data ingestion and intelligent processing, comprising:
performing initial household data population;
receiving ongoing data inputs from a plurality of supplementary input sources;
recording provenance metadata for at least one received data input;
applying a multi-stage processing pipeline to at least one received document;
executing an analytics population;
populating a plurality of domain-specific analytics tables organized by planning category;
identifying action items and key dates from the populated analytics tables; and
generating automated reminders to users via the consumer-facing application based on the identified action items and key dates, thereby creating a continuous data collection cycle.
